(19) United States
(12) Patent Application Publication
(10) Pub. No.: US 2021/0033028 A1
(43) Pub. Date: Feb. 4, 2021

(54) SEAL ASSEMBLY

(71) Applicant: Solar Turbines Incorporated, San Diego, CA (US)

(72) Inventors: Gareth W. Oskam, San Diego, CA (US); Paul Economo, San Diego, CA (US); Samantha Caldwell Rogers, San Diego, CA (US)

(73) Assignee: Solar Turbines Incorporated, San Diego, CA (US)

(21) Appl. No.: 16/530,614

(22) Filed: Aug. 2, 2019

(51) Int. Cl. F02C 7/28; F16J 15/32

(52) U.S. Cl. CPC F02C 7/28; F16J 15/32; F05D 2240/35; F05D 2240/55; F05D 2220/32

(57) ABSTRACT

This disclosure provides a seal assembly to provide a generally smooth transition from a combustion chamber to a turbine within a gas turbine engine. A seal body extends from the combustion chamber towards the turbine and is positioned to seal against unwanted flows between the combustion chamber and a compressed air chamber.

### TECHNICAL FIELD

This disclosure relates to gas turbine engines. More specifically, this disclosure relates to a seal assembly between a combustor and a turbine.

### BACKGROUND

Generally described, turbo-machinery such as gas turbine engines and the like include a main gas flow path extending therethrough. Gas leakage, either out of the gas flow path or into the gas flow path, may lower overall gas turbine efficiency, increase fuel costs, and possibly increase emission levels. Secondary flows also may be used within the gas turbine engine to cool the various heated components. Specifically, cooling air may be extracted from the later stages of the compressor for use in cooling the heated components and for purging gaps and cavities between adjacent components. Seals may be used at junctions between the combustor and the turbine sections. Seals however, may be spaced apart, resulting in leakage flow escaping through gaps in between the segment seals and may create rough transition surfaces. Leakage flow and disrupted flow along the rough transition surface may result in reduced efficiency of the gas turbine.

U.S. Pat. No. 9,863,323 to Kirtley et. al describes improved gas turbine component sealing. In one example embodiment, a gas turbine segment seal assembly may include a first tapered segment seal with a first tapered portion having a first tapered surface and a first taper angle. The gas turbine segment seal assembly may include a second tapered segment seal with a second tapered portion having a second tapered surface and a second taper angle. The gas turbine segment seal assembly may include a seal pin positioned in between the first tapered segment seal and the second segment seal and adjacent to the first tapered surface and the second tapered surface.

The present disclosure is directed toward overcoming one or more of the problems discovered by the inventors.

### SUMMARY

In general, this disclosure describes a seal assembly for a gas turbine engine. The gas turbine engine can include a combustor, a turbine, and a center axis extending longitudinal to the gas turbine engine. The combustor having an outer liner partially forming a combustion chamber. The turbine having a nozzle housing configured to surround a turbine rotor assembly and turbine nozzles. The forward end of the nozzle housing located adjacent to an aft end of the combustion chamber. The seal assembly providing a transition from the combustion chamber to the nozzle housing. The seal assembly comprises a fixed body, a clamping body and a seal body. The fixed body configured to radially extend around the center axis and shaped to mate with the forward end of the nozzle housing. The clamping body configured to radially extend around the center axis. The clamping body configured to be positioned between the combustion chamber and the turbine. The seal body extends from the aft end of the outer liner. A portion of the seal body configured to be positioned between the clamping body and the nozzle housing.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a schematic illustration of an exemplary gas turbine engine;

FIG. 2 is a section view of a portion of the combustor and nozzle section from FIG. 1 with an exemplary combustor seal assembly;

FIG. 3 is a section view of a portion of the combustor and nozzle section from FIG. 1 with another exemplary combustor seal assembly;

FIG. 4 is a section view of a portion of the combustor and nozzle section from FIG. 1 with another exemplary combustor seal assembly;

FIG. 5 is a section view of a portion of the combustor and nozzle section from FIG. 1 with another exemplary combustor seal assembly;

FIG. 6 is a section view of a portion of the combustor and nozzle section from FIG. 1 with another exemplary combustor seal assembly; and

FIG. 7 is a section view of a portion of the combustor and nozzle section from FIG. 1 with another exemplary combustor seal assembly.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

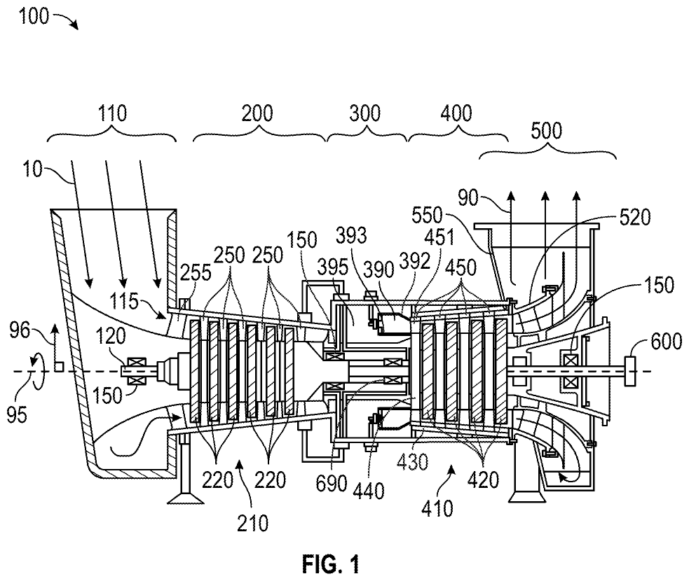

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air 10 (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from center axis 95, wherein a radial 96 may be in any direction perpendicular and radiating outward from center axis 95.

A gas turbine engine 100 includes an inlet 110, a shaft 120, a compressor 200, a combustor 300, a turbine 400, an exhaust 500, and a power output coupling 600. The gas turbine engine 100 may have a single shaft or a dual shaft configuration.

The compressor 200 includes a compressor rotor assembly 210, compressor stationary vanes (stators) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages. Inlet guide vanes 255 axially precede the compressor stages at the beginning of an annular flow path 115 through the gas turbine engine 100.

The combustor 300 includes a combustion chamber 390 and a compressed air chamber 395. Combustion chamber 390 may be partially formed by an outer liner 392 and an inner liner 393. Outer liner 392 may define the outer boundary of combustion chamber 390 and may generally include a hollow cylinder shape. Inner liner 393 may be located radially inward from outer liner 392. Inner liner 393 may define the inner boundary of combustion chamber 390 and may generally include a hollow cylinder shape. The compressed air chamber 395 is located outside of the combustion chamber 390.

The turbine 400 includes a turbine rotor assembly 410 and turbine nozzles 450 within a nozzle housing 430. The nozzle housing 430 surrounds the turbine rotor assembly 410 and the turbine nozzles 450 and the forward end 438 of the nozzle housing 430 is located adjacent to the aft end of the combustion chamber 390. The turbine rotor assembly 410 mechanically couples to the shaft 120. In the embodiment illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine 400 includes multiple turbine stages.

The exhaust 500 includes an exhaust diffuser 520 and an exhaust collector 550 that can collect exhaust gas 90. The power output coupling 600 may be located at an end of shaft 120.

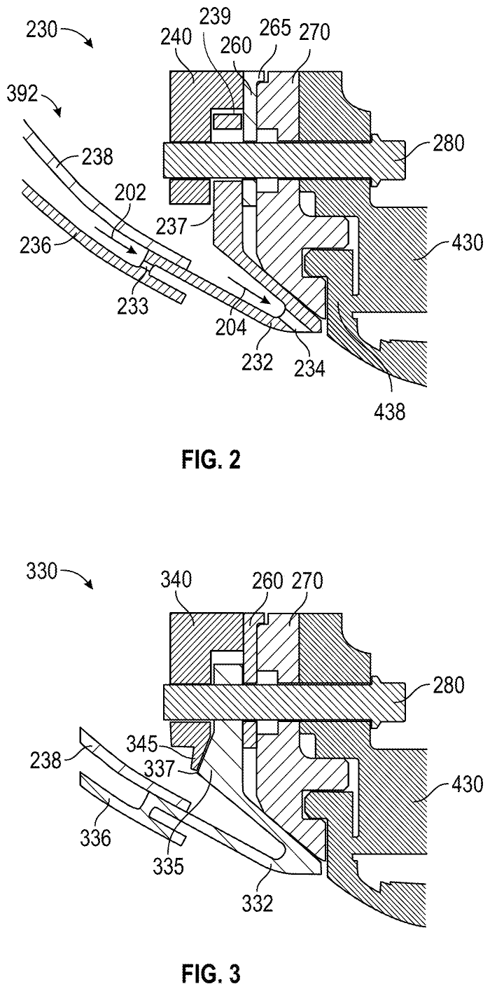

FIG. 2 is a section view of a portion of the combustor and nozzle section from FIG. 1 with an exemplary combustor seal system. Some features are not shown and/or not labelled for ease of viewability. As illustrated, combustion chamber 390 may be a double walled chamber. In particular, outer liner 392 includes two liners extending radially around the center axis 95: an exterior outer liner 238 and an interior outer liner 236. Exterior outer liner 238 may form an exterior barrier, and the interior outer liner 236 may form an interior barrier. Interior outer liner 236 may be located radially inward from exterior outer liner 238, partially forming the combustion chamber 390 with an annular shape there between. Cooling air 202 can pass between the interior outer liner 236 and the exterior outer liner 238. The interior outer liner 236 and exterior outer liner 238 can form part of a sealing assembly 230.

The sealing assembly 230 can include a portion of the combustor 300 and a portion of the turbine 400, for example outer liner 392 and nozzle housing 430. The sealing assembly 230 can circumferentially extend around the center axis 95.

The interior outer liner 236 can have a portion located at its aft end referred to as the seal body 232. The seal body 232 can extend radially around the center axis 95. In other words, the seal body 232 can circumferentially extend around the center axis 95. The seal body 232 can be located upstream of the nozzle housing 430. In other words, the seal body 232 can extend from outer liner 392 to proximate the nozzle housing 430 and provide a generally smooth transition from the combustion chamber 390 to the nozzle housing 430. A portion of the seal body 232 can extend outwards of the exterior outer liner 238. The seal body 232 can have a curved shape located proximate to the nozzle housing 430. The seal body 232 can extend from proximate the nozzle housing 430 diagonally outwards and in the forward direction and transition to extending generally outwards. A portion of the seal body 232 can contact the exterior outer liner 238. The seal body 232 can have a first passage 233 allowing cooling air 202 to pass through the seal body 232 and be in flow communication with the combustion chamber 390 and turbine 400. The first passage 233 can be a series of holes spaced around the circumference of the seal body 232. The seal body 232 can have a second passage 234 allowing cooling air 204 from the compressed air chamber 395 to pass through the seal body 232 and be in flow communication with the combustion chamber 390 and turbine 400. The second passage 234 can be a series of holes spaced around the circumference of the seal body 232. The second passage 234 can be a row of holes in extending outward towards the fixed body 270. In an example the seal body 232 can extend from the exterior outer liner 238.

The sealing assembly 230 can include a clamping body 240. The clamping body 240 can be positioned within the combustor 300 and outside of the combustion chamber 390 and outer liner 392. In other words the clamping body 240 can be located within the compressed air chamber 395. The clamping body 240 can extend radially around the center axis 95. The clamping body 240 can be located upstream of the nozzle housing 430. The clamping body 240 can be located adjacent to a forward facing surface 237 of the seal body 232 and an outward facing surface 239 of the seal body 232. The clamping body 240 can contact the seal body 232 along the forward facing surface 237 of the seal body 232 and the outward facing surface 239 of the seal body 232.

The sealing assembly 230 can include a fixed body 270. The fixed body 270 can radially extend around the center axis 95. The fixed body 270 can be positioned between the nozzle segment 430 and the seal body 232. The fixed body 270 can be shaped to mate with a forward end 438 of the nozzle segment 430. A portion of the fixed body 270 can be in contact with a portion of the seal body 232. In an example the fixed body 270 is a portion of the nozzle housing 430 and is not separate piece.

The sealing assembly 230 can include a friction plate 260. The friction plate 260 can radially extend around the center axis 95. The friction plate 260 can be positioned between the fixed body 270 and the seal body 232. The friction plate 260 may have a flange portion 265, located at the outward end of the friction plate 260, and shaped to mate with the fixed body 270. A portion of the friction plate 260 can be in contact with a portion of the seal body 232. A portion of the friction plate 260 can be in contact with the clamping body 240. A portion of the friction plate 260 can be in contact with the fixed body 270. In an example, the friction plate 260 and the fixed body 270 are joined together and considered portions of the same part and are not separate parts.

The sealing assembly can include a mounting bolt 280 that can extend through the nozzle housing 430, the fixed body 270, the friction plate 260, the seal body 232, and the clamping body 240.

FIG. 3 is a section view of a portion of the combustor and nozzle section from FIG. 1 with another exemplary combustor seal system. Structures and features previously described in connection with earlier described embodiments may not be repeated here with the understanding that, when appropriate, that previous description applies to the embodiment depicted in FIG. 3. Additionally, the emphasis in the following description is on variations of previously introduced features or elements.

A sealing assembly 330 can include an interior outer liner 336, the exterior outer liner 238, a clamping body 340, the friction plate 260, the fixed body 270, and the nozzle housing 430. The interior outer liner 336 can include a seal body 332. The seal body 332 may have a protrusion 335 that can have a triangular shape with a tip 337 extending towards the forward end of the gas turbine engine 100. The protrusion 335 can taper and narrow as the protrusion 335 extends outward. The clamping body 340 can have a protrusion 345 that protrudes inwards and has a surface shaped to match the protrusion 335 of the seal body 332. The protrusion 345 can taper and narrow as the protrusion 345 extends inwards.

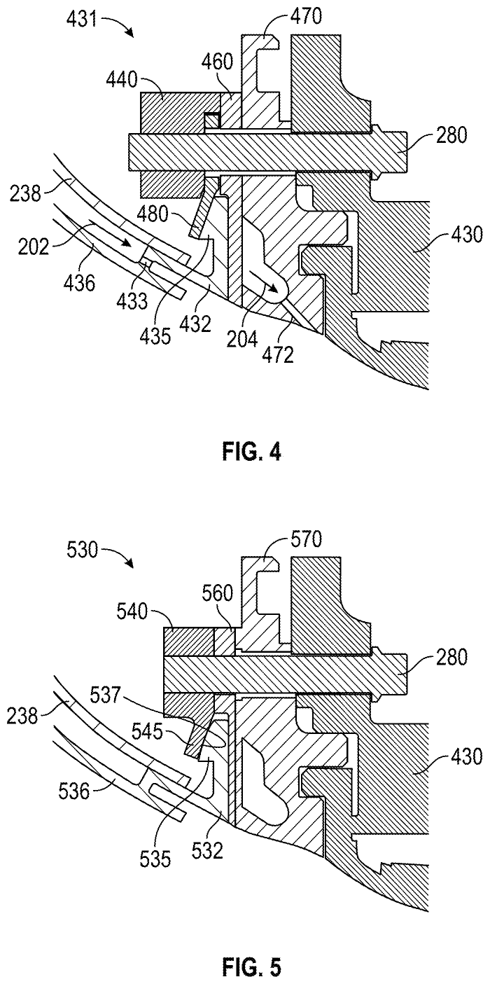

FIG. 4 is a section view of a portion of the combustor and nozzle section from FIG. 1 with another exemplary combustor seal system. Structures and features previously described in connection with earlier described embodiments may not be repeated here with the understanding that, when appropriate, that previous description applies to the embodiment depicted in FIG. 4. Additionally, the emphasis in the following description is on variations of previously introduced features or elements.

A sealing assembly 431 can include an interior outer liner 436, the exterior outer liner 238, a clamping body 440, a grommet ring 480, a friction plate 460, a fixed body 470, and the nozzle housing 430. The interior outer liner 436 can include a seal body 432. The seal body 432 can extend from proximate the exterior outer liner 238 towards the nozzle housing 430 and transition generally outwards. The seal body 432 can have a protrusion 435 having a triangular shape located at the outward end of the seal body 432.

The seal body 432, friction plate 460, and fixed body 470 can be a generally smooth transition from the combustion chamber 390 to the nozzle housing 430.

The grommet ring 480 can be positioned between the clamping body 440 and the friction plate 460. The grommet ring 480 can contact a surface of the protrusion 435 of the seal body 432.

The fixed body 470 can have a fixed body passage 472 for allowing cooling air 204 to enter the turbine section 400.

The mounting bolt 280 can extend through the nozzle housing 430, the fixed body 470, the friction plate 460, the grommet ring 480, and the clamping body 440.

FIG. 5 is a section view of a portion of the combustor and nozzle section from FIG. 1 with another exemplary combustor seal system. Structures and features previously described in connection with earlier described embodiments may not be repeated here with the understanding that, when appropriate, that previous description applies to the embodiment depicted in FIG. 5. Additionally, the emphasis in the following description is on variations of previously introduced features or elements.

A sealing assembly 530 can include an interior outer liner 536, the exterior outer liner 238, a clamping body 540, a friction plate 560, a fixed body 570, and the nozzle housing 430. The interior outer liner 536 can include a seal body 532. The seal body 532 can have a protrusion 535 located at the outward end of the seal body 532. The protrusion 535 of the seal body 532 can have a curved surface 537.

The clamping body 540 can have a protrusion 545 that can contact the curved surface 537 of the protrusion 535 of the seal body 532.

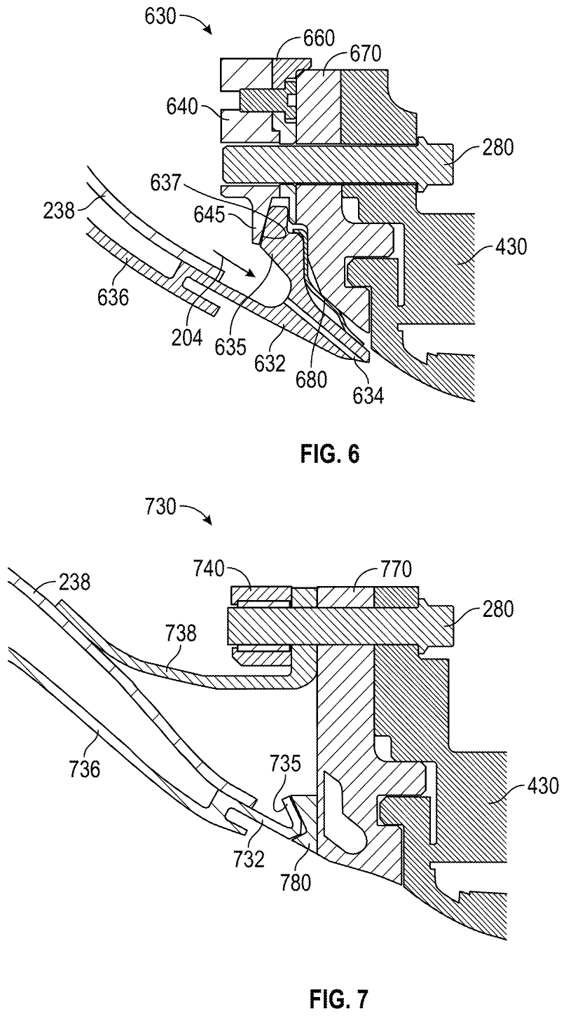

FIG. 6 is a section view of a portion of the combustor and nozzle section from FIG. 1 with another exemplary combustor seal system. Structures and features previously described in connection with earlier described embodiments may not be repeated here with the understanding that, when appropriate, that previous description applies to the embodiment depicted in FIG. 6. Additionally, the emphasis in the following description is on variations of previously introduced features or elements.

A sealing assembly 630 can include an interior outer liner 636, the exterior outer liner 238, a clamping body 640, a friction plate 660, a spring seal 680, a fixed body 670, and the nozzle housing 430. The interior outer liner 636 can include a seal body 632. The seal body 632 can have a protrusion 635 forming the outward end of the seal body 632 and formed to mate with a portion of the fixed body 670 and a portion of the friction plate 660. The protrusion 635 of the seal body 632 can have a curved surface 637.

The clamping body 640 can have a protrusion 645 that can contact the curved surface 637 of the protrusion 635 of the seal body 632.

The spring seal 680 can be positioned between the seal body 632 and the fixed body 670.

FIG. 7 is a section view of a portion of the combustor and nozzle section from FIG. 1 with another exemplary combustor seal system. Structures and features previously described in connection with earlier described embodiments may not be repeated here with the understanding that, when appropriate, that previous description applies to the embodiment depicted in FIG. 7. Additionally, the emphasis in the following description is on variations of previously introduced features or elements.

A sealing assembly 730 can include an interior outer liner 736, the exterior outer liner 238, a support member 738, a clamping body 740, a fixed body 770, a fixed piece 780, and the nozzle housing 430. The interior outer liner 736 can include a seal body 732. The seal body 732 can have a portion 735 forming the outward end of the seal body 732 and formed to mate with a portion of the fixed piece 780.

The fixed piece 780 can be position between the seal body 732 and the fixed body 770 and be shaped to mate with the portion 735 of the seal body 732. The fixed piece 780 can be affixed to the fixed body 770 with a bolt, by welding, or other fastening and joining methods. In an example, the fixed piece 780 and fixed body 770 can be one single piece.

The axial support member 738 can extend from the exterior outer liner 238 to between the clamping body 740 and the fixed body plate 775.

The sealing assembly 730 can include a mounting bolt 280 extending through the nozzle housing 430, the fixed body 770, the fixed body plate 775, the axial support member 738, and the clamping body 740.

### INDUSTRIAL APPLICABILITY

During operation, combustion gases pass from the combustor 300 into the turbine 400. There can be a gap between the combustion chamber 390 of the combustor 300 and the nozzle housing 430 of the turbine 400. This gap can allow uncontrolled flow of compressed cooling air 204 into the turbine 400 and lead to reduced turbine efficiency and engine power. A sealing assembly 230, 330, 431, 530, 630, 730 can provide a generally smooth surface between the combustion chamber 390 and the nozzle housing 430 that provides a seal between the combustion chamber 390 and compressed air chamber 395.

In the embodiment from FIG. 2, the seal body 232 extends from proximate the exterior outer liner 228 to proximate the nozzle housing 430. In other words the seal body 232 can span the space between the outer liner 392 of the combustion chamber 390 towards the nozzle housing 430 of the turbine 400, leaving a gap between the seal body 232 and the nozzle housing 430 prior to startup of the gas turbine engine 100. The gap between the seal body 232 and the nozzle housing 430 is sealed by the interface between the seal body 232 and the fixed body 270 as the combustion of fuel causes temperatures of the components to increase and therefore expand. The seal body 232 can be flexible and can move during operation of the gas turbine engine 100. The clamping body 240 and mounting bolt 280 can be used to align components of the seal assembly 230 for assembly and can.

During operation of the gas turbine engine 100, pressure from the cooling air 204 within the compressed air chamber 395 and combustion gases within the combustion chamber 390 can apply pressure in the aft direction and press the seal body 232 against the fixed body 270 to provide a seal or provide for a stronger seal. The pressure from the cooling air 204 and combustion gases can be generally in the aft direction and hold the seal body 232 in position while allowing radial movement of the seal body 232. In an example the pressure provided by the cooling air 204 from the compressed air chamber 395 is greater than the pressure provided by the combustion gases.

The seal body 232 can have a first passage 233 and second passage 234 to allow cooling air 202 and cooling air 204, respectively, to pass through the seal body 232 to provide cooling to the turbine 400. In an example cooling air 202 enters through first passage 233 and exits proximate to the aft end of the combustion chamber 390. In an example cooling air 204 enters through second passage 234 and exits proximate the forward end 438 of the nozzle housing 430 of the turbine 400 to provide surface cooling.

In the embodiment from FIG. 3, the seal body 332 interfaces with the clamping body 340 to provide a seal. Similar to the embodiment to FIG. 2, the cooling air 204 and the combustion gasses can provide pressure that holds the seal body 332 in place while allowing radial movement of the seal body 332. The interface between the seal body 332 and the friction plate 260 can provide a seal. The clamping body 340 and mounting bolt 280 can be used to align components of the seal assembly 330 for assembly and can apply additional force between the seal body 332 and the clamping body 340 and can improve sealing performance. The clamping body 340 can include a protrusion 345 that can interface with the protrusion 335 of the seal body 332 to provide a seal between the seal body 332 and the clamping body 340. The tapered shape of the protrusion 345 of the clamping body 340 and the protrusion 335 of the seal body 332 can interface through thermal expansion and pressure differential between the combustion chamber 390 and the compressed air chamber 395. The seal body 332 can expand outward as the seal body 332 transitions from a cold to hot temperature.

In the embodiment from FIG. 4, the seal body 432 interfaces with the grommet ring 480 to provide a seal. Similar to the embodiments to FIG. 2 and FIG. 3, the cooling air 204 and the combustion gasses can provide pressure that holds the seal body 432 in place while allowing radial movement of the seal body 432 from an increase in temperature. The interface between the seal body 432 and the friction plate 460 can provide a seal. The clamping body 440 and mounting bolt 280 can be used to align components of the seal assembly 431 for assembly and can apply additional force to a grommet ring 480 and friction plate 460. The grommet ring 480 can interface with the seal body 432 to provide a seal and transfer the force from the clamping body 440 to provide or improve the seal. The grommet ring 480 can be flexible enough to allow for differing axial movement of the seal body 432.

The fixed body 470 can have a fixed body passage 472 that allows cooling air 204 from the compressed air chamber 395 to pass through the fixed body 470 and act as surface cooling proximate to the beginning of the turbine 400. The fixed body 470 may include passages (not shown) that are in fluid communication with the compressed air chamber 395 and provide cooling air 204 to enter the fixed body passage 472.

The seal body 432, friction plate 460, and fixed body 470 can provide a generally smooth transition between the combustion chamber 390 and the nozzle housing 430. In other words the seal body 432, friction plate 460, and fixed body 470 generally span the distance between the outer liner 392 and the nozzle housing 430.

In the embodiment from FIG. 5, the seal body 532 interfaces with the clamping body 540 to provide a seal. Similar to the embodiments to FIGS. 2-4, the cooling air 204 and the combustion gasses can provide pressure that that holds the seal body 532 in place while allowing radial movement of the seal body 532. The interface between the seal body 532 and the friction plate 560 can provide a seal. The clamping body 540 and mounting bolt 280 can be used to align components of the seal assembly 530 for assembly and can apply additional force to the seal body 532. The clamping body 540 can interface with the seal body 532 and transfer a sealing force from the protrusion 545 to the protrusion 535 of the seal body 532 to provide or improve the seal. The protrusion 535 can have a curved surface 537 that can help provide a seal as the friction plate 560 wears during loading cycles of the gas turbine engine 100.

In the embodiment from FIG. 6, the seal body 632 interfaces with the clamping body 640 to provide a seal. Similar to the embodiment to FIGS. 2-5, the cooling air 204 and the combustion gasses can provide pressure that that holds the seal body 632 in place while allowing radial movement of the seal body 632. The clamping body 640 and mounting bolt 280 can be used to align components of the seal assembly 630 for assembly and can apply additional force between the seal body 632 and the clamping body 640 and may improve the seal performance. The clamping body 640 can include a protrusion 645 that can interface with the protrusion 635 of the seal body 632 to provide an additional force and improve the seal. The tapered shape of the protrusion 645 of the clamping body 640 and the protrusion 635 of the seal body 632 can interface through thermal expansion. The protrusion 635 can have a curved surface 637 that can help maintain a seal as the friction plate 660 wears during loading cycles of the gas turbine engine 100.

The spring seal 680 can be preload and placed between the seal body 632 and the fixed body 670 to provide a seal when the seal body 632 and the clamping body 640 are not in contact yet, such as during starting conditions.

In the embodiment from FIG. 7, the seal body 732 interfaces with the fixed piece 780 to provide a seal. The shape of the seal body 732 and fixed piece 780 can provide for multiple sealing interfaces. The axial support member can be for support the outer liner 392 weight and axial loads.

Any explanation in connection with one embodiment applies to similar features of the other embodiments, and elements of multiple embodiments can be combined to form other embodiments. Furthermore, there is no intention to be bound by any theory presented in the preceding background or detailed description. It is also understood that the illustrations may include exaggerated dimensions to better illustrate the referenced items shown, and are not consider limiting unless expressly stated as such.

Although this invention has been shown and described with respect to detailed embodiments thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of gas turbine engine. For example, the described embodiments may be applied to stationary or motive gas turbine engines, or any variant thereof. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

It will be understood that the benefits and advantages described above may relate to one embodiment or may relate to several embodiments. The embodiments are not limited to those that have any or all of the stated benefits and advantages.

What is claimed is:

1. A seal assembly for a gas turbine engine with a combustor, a turbine, and a center axis extending longitudinal to the gas turbine engine, the combustor having an outer liner partially forming a combustion chamber, the turbine having a nozzle housing configured to surround a turbine rotor assembly and turbine nozzles, a forward end of the nozzle housing located adjacent to an aft end of the combustion chamber, the seal assembly providing a transition from the combustion chamber to the nozzle housing, the seal assembly comprising:
a fixed body configured to radially extend around the center axis and shaped to mate with the forward end of the nozzle housing;
a clamping body configured to radially extend around the center axis, the clamping body configured to be positioned between the combustion chamber and the fixed body; and
a seal body extending from the aft end of the outer liner, a portion of the seal body configured to be positioned between the clamping body and the nozzle housing.

2. The seal assembly of claim 1, wherein a portion of the seal body contacts the fixed body and provides a seal.

3. The seal assembly of claim 1, wherein a portion of the seal body has a curved surface that is in contact with the clamping body.

4. The seal assembly of claim 1, further comprising a fixed piece located between the seal body and fixed body, the fixed piece shaped to mate with a portion of the seal body to provide a seal.

5. The seal assembly of claim 1, further comprises a grommet ring positioned between the clamping body and the seal body, the grommet ring providing a force against a portion of the seal body.

6. The seal assembly of claim 1, further comprising a mounting bolt extending through the clamping body, the fixed body, and the nozzle housing.

7. The seal assembly of claim 1, wherein the seal body includes a first passage located proximate to an aft end of the combustion chamber, and a second passage located proximate to an aft end of the seal body.

8. A seal assembly for a gas turbine engine with a combustor having a combustion chamber, a turbine, and a center axis extending longitudinal to the gas turbine engine, the turbine having a nozzle housing configured to surround a turbine rotor assembly and turbine nozzles, a forward end of the nozzle housing located adjacent to an aft end of the combustion chamber, the seal assembly comprising:
an outer liner positioned within the combustor, partially forming the combustion chamber, the outer liner having
a seal body forming an aft end of the outer liner and extending towards the nozzle housing, the seal body circumferentially extending around the center axis; and
a clamping body positioned within the combustor and outside of the outer liner, the clamping body shaped and positioned to contact a surface of the seal body.

9. The seal assembly of claim 8, wherein the seal body provides a generally smooth transition from the combustion chamber to the nozzle housing.

10. The seal assembly of claim 8, further comprising:
a fixed body shaped to mate with the nozzle housing and positioned between the seal body and the nozzle housing; and
a friction plate located between a portion of the seal body and the fixed body.

11. The seal assembly of claim 10, wherein the seal body interfaces with the friction plate to create a seal.

12. The seal assembly of claim 10, wherein the seal body, the friction plate, and the fixed body form a generally smooth transition from the combustion chamber to the nozzle housing.

13. The seal assembly of claim 10, wherein a portion of the seal assembly provides a seal by contacting the fixed body.

14. The seal assembly of claim 10, further comprising a spring seal positioned between the seal body and the fixed body.

15. A gas turbine engine comprising:
a turbine including a nozzle housing configured to surround a turbine rotor assembly and turbine nozzles, a forward end of the nozzle housing located adjacent to an aft end of the combustion chamber;
a combustor positioned proximate to a forward end of the turbine and including an exterior outer liner,
a compressed air chamber located outward of the exterior outer liner,
a clamping body located within the compressed air chamber and proximate to an aft end of the exterior outer liner, and
an interior outer liner located inward of the exterior outer liner, the interior outer liner partially forming a combustion chamber, and having a seal body forming an aft end of the interior outer liner, the seal body extending towards the turbine, the seal body creating a seal between the combustion chamber and the compressed air chamber; and
a mounting bolt connecting the clamping body to the turbine.

16. The gas turbine engine of claim 15, the gas turbine engine further comprising an axial support member extending from the exterior outer liner to between the clamping body and the turbine.

17. The gas turbine engine of claim 16, further comprising a fixed piece located between the seal body and fixed body, the fixed piece shaped to mate with a portion of the seal body to provide a seal.

18. The gas turbine engine of claim 15, wherein the seal body includes a first passage located proximate to an aft end of the combustion chamber, and a second passage extending from the compressed air chamber to proximate the aft end of the combustion chamber.

19. The gas turbine engine of claim 15, the gas turbine engine further comprising:
a fixed body shaped to mate with the nozzle housing and positioned between the seal body and the nozzle housing; and
a friction plate located between a portion of the seal body and the fixed body, providing a seal with the seal body.

20. The gas turbine engine of claim 19, wherein the mounting bolt fastens together the clamping body, the seal body, the friction plate, the fixed body, and the nozzle housing.
